(19) United States
(12) Patent Application Publication
(10) Pub. No.: US 2013/0314293 A1
(43) Pub. Date: Nov. 28, 2013

(54) COMMUNICATION DEVICE AND ANTENNA SYSTEM THEREIN

(71) Applicants: Kin-Lu WONG, Kaohsiung City (TW); Huan-Jynu JIANG, Kaohsiung City (TW)

(72) Inventors: Kin-Lu WONG, Kaohsiung City (TW); Huan-Jynu JIANG, Kaohsiung City (TW)

(73) Assignee: Acer Incorporated, Taipei Hsien (TW)

(21) Appl. No.: 13/592,790

(22) Filed: Aug. 23, 2012

(30) Foreign Application Priority Data
May 25, 2012 (TW) 101118655

(51) Int. Cl. H01Q 1/48

(52) U.S. Cl. 343/848

(57) ABSTRACT

A communication device including a first conductive plane and an antenna system is provided. The antenna system includes at least a first antenna, a second antenna and a ground plane, and the antenna system is located at a first edge of the first conductive plane. Both the first antenna and the second antenna operate in at least a first band. The ground plane substantially has an inverted T-shape and includes a main ground plane and a protruded ground plane. The main ground plane is coupled to the first conductive plane. The protruded ground plane is located between the first antenna and the second antenna. The ground plane has at least a first slot. A portion of the first slot is located in the protruded ground plane, and two closed ends of the first slot are located in the main ground plane and extend away from each other.

### CROSS REFERENCE TO RELATED APPLICATIONS

This application claims priority of Taiwan Patent Application No. 101118655 filed on May 25, 2012, the entirety of which is incorporated by reference herein.

### BACKGROUND OF THE INVENTION

1. Field of the Invention

The disclosure generally relates to a communication device, and more particularly, relates to a communication device comprising a MIMO (Multi-Input Multi-Output) antenna system with high isolation.

2. Description of the Related Art

As people demand more and more signal transmissions and transmission rates thereof, relative communication standards support higher and higher data transmission rates. A system with multiple antennas is required to be capable of receiving and transmitting signals at the same time. For example, the communication standard of IEEE 802.11n for WLAN (Wireless Local Area Network) can support a MIMO operation to increase transmission rate. As a matter of fact, it is a future trend to use multiple antennas in a mobile device. Since multiple antennas should be disposed in a limited space of a mobile device, these antennas are very close to each other and result in serious interference. Keeping high isolation between these antennas seems to be a critical challenge for a designer.

Traditionally, the method for improving isolation and for reducing mutual coupling in a system with multiple antennas is performed by disposing a parasitic isolation metal element between two adjacent antennas, wherein the resonant frequency of the parasitic isolation metal element is very close to that of the antennas so as to reject current coupling between the antennas, thereby increasing the isolation between the antennas. However, such a method usually leads to decreased radiation efficiency and degraded radiation performance due to the parasitic isolation metal element acting as a radiator as well.

Accordingly, there is a need to design a new communication device comprising an antenna system, which not only has high isolation between antennas therein but also maintains radiation efficiency thereof, or even enhances radiation efficiency.

### BRIEF SUMMARY OF THE INVENTION

The invention is aimed to provide a communication device comprising an antenna system. The antenna system comprises at least two antennas, and the antennas have high isolation therebetween and good radiation efficiency.

In a preferred embodiment, the disclosure is directed to a communication device, comprising: a first conductive plane; and an antenna system, being substantially a planar structure, and substantially located at a first edge of the first conductive plane, wherein the antenna system comprises: a first antenna, operating in at least a first band; a second antenna, operating in at least the first band; and a ground plane, substantially having an inverted-T shape, and comprising a main ground plane and a protruded ground plane, wherein the main ground plane is coupled to the first conductive plane, the protruded ground plane is located between the first antenna and the second antenna, the ground plane has at least a first slot, a length of the first slot is approximately equal to 0.5 wavelength of a frequency in the first band, a portion of the first slot is located in the protruded ground plane, the first slot has a first closed end and a second closed end, and the first closed end and the second closed end are located in the main ground plane and extend away from each other, and the first slot increases isolation between the first antenna and the second antenna.

Note that the antenna system of the invention uses resonance of the first slot in the first band to attract surface currents on the ground plane, thereby reducing current coupling between the antennas. Accordingly, the antenna system can have good isolation between the antennas without affecting radiation efficiency.

In an embodiment, the ground plane further has a second slot, and the length of the second slot is approximately equal to 0.5 wavelength of a frequency in a second band. A portion of the second slot is located in the main ground plane, and another portion of the second slot is located in the protruded ground plane. The second slot can resonate in the second band to attract surface currents on the ground plane further to reduce current coupling between the antennas, thereby increasing the isolation between the first antenna and second antenna in the second band.

In another embodiment, the ground plane further has an open slot. An open end of the open slot is located at an edge of the protruded ground plane. The length of the open slot is approximately equal to 0.5 wavelength of a frequency in the second band. The open slot can resonate in the second band to attract surface currents on the ground plane further to reduce current coupling between the antennas, thereby increasing the isolation between the first antenna and second antenna in the second band.

In an embodiment, the antenna system has the isolation (S21) of about −22 dB in the first band, and has the isolation (S21) of about −23 dB in the second band. At the same time, the antenna system still has good radiation efficiency.

### BRIEF DESCRIPTION OF DRAWINGS

The invention can be more fully understood by reading the subsequent detailed description and examples with references made to the accompanying drawings, wherein:

FIG. 1A is a diagram for illustrating a communication device according to a first embodiment;

FIG. 1B is a diagram for illustrating a communication device according to a second embodiment;

FIG. 2 is a diagram for illustrating an antenna system according to an embodiment;

FIG. 3 is a diagram for illustrating the antenna system according to another embodiment;

FIG. 4 is a diagram for illustrating the antenna system according to an embodiment; and

FIG. 5 is a diagram for illustrating S parameters of the antenna system 14 shown in FIG. 4 according to an embodiment.

### DETAILED DESCRIPTION OF THE INVENTION

In order to illustrate the foregoing and other purposes, features and advantages of the invention, the embodiments and figures thereof in the invention are shown in detail as follows.

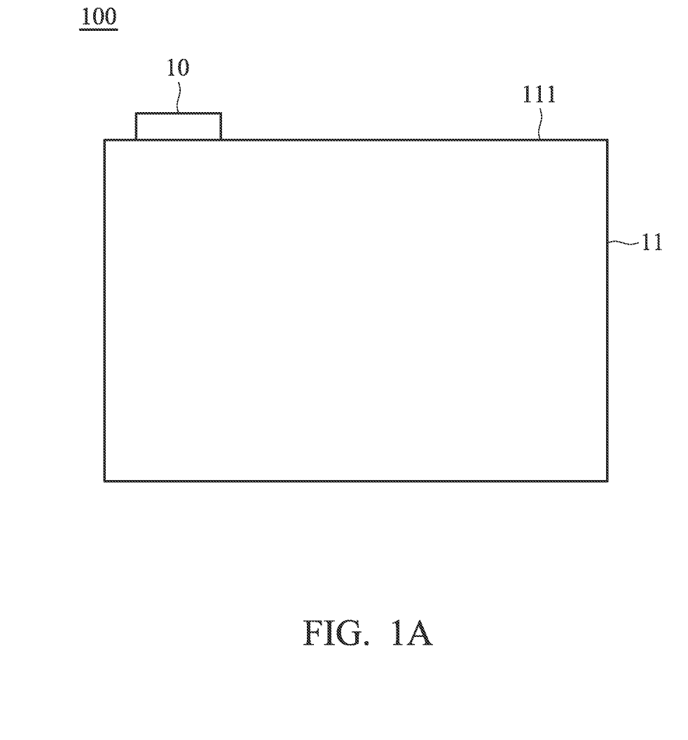

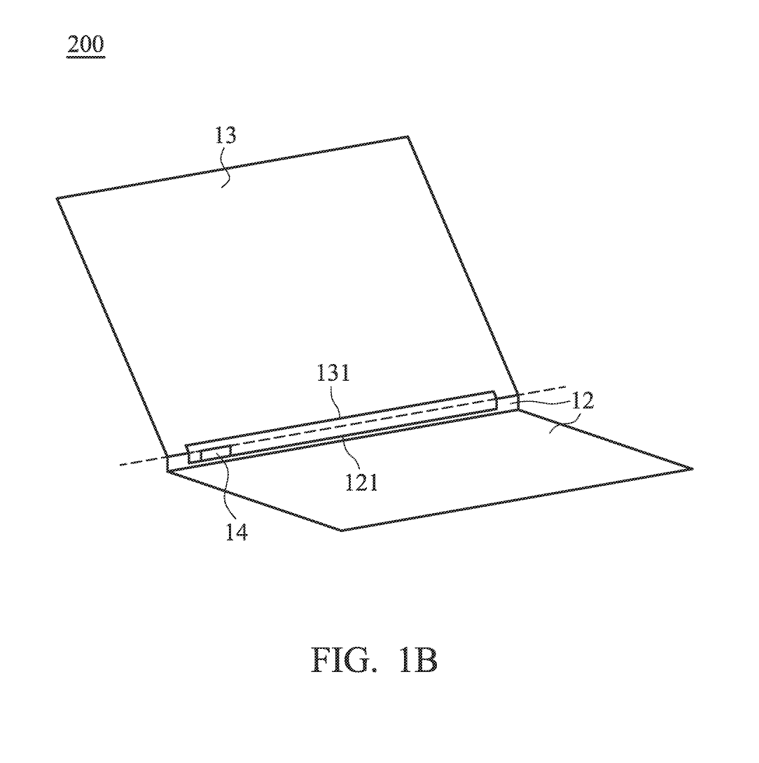

FIG. 1A is a diagram for illustrating a communication device 100 according to a first embodiment. In the embodiment, the communication device 100 comprises an antenna system 10 and a first conductive plane 11, wherein the first conductive plane 11 has a first edge 111. The first conductive plane 11 may be a supporting conductive board of a tablet computer, or may be a supporting conductive board of an upper cover of a notebook computer. The antenna system 10 is substantially located at the first edge 111 of the first conductive plane 11. The antenna system 10 is substantially a planar structure, and the antenna system 10 is disposed on a plane, which is substantially parallel to the first conductive plane 11 and extends away from the first conductive plane 11.

FIG. 1B is a diagram for illustrating a communication device 200 according to a second embodiment. In the embodiment, the communication device 200 comprises a first conductive plane 12, a second conductive plane 13, and an antenna system 14. The first conductive plane 12 is electrically coupled to the second conductive plane 13. A second edge 131 of the second conductive plane 13 is close to a first edge 121 of the first conductive plane 12. The second conductive plane 13 may be a supporting conductive board of an upper cover of a notebook computer. An antenna system 14 is substantially disposed between the first edge 121 of the first conductive plane 12 and the second edge 131 of the second conductive plane 13.

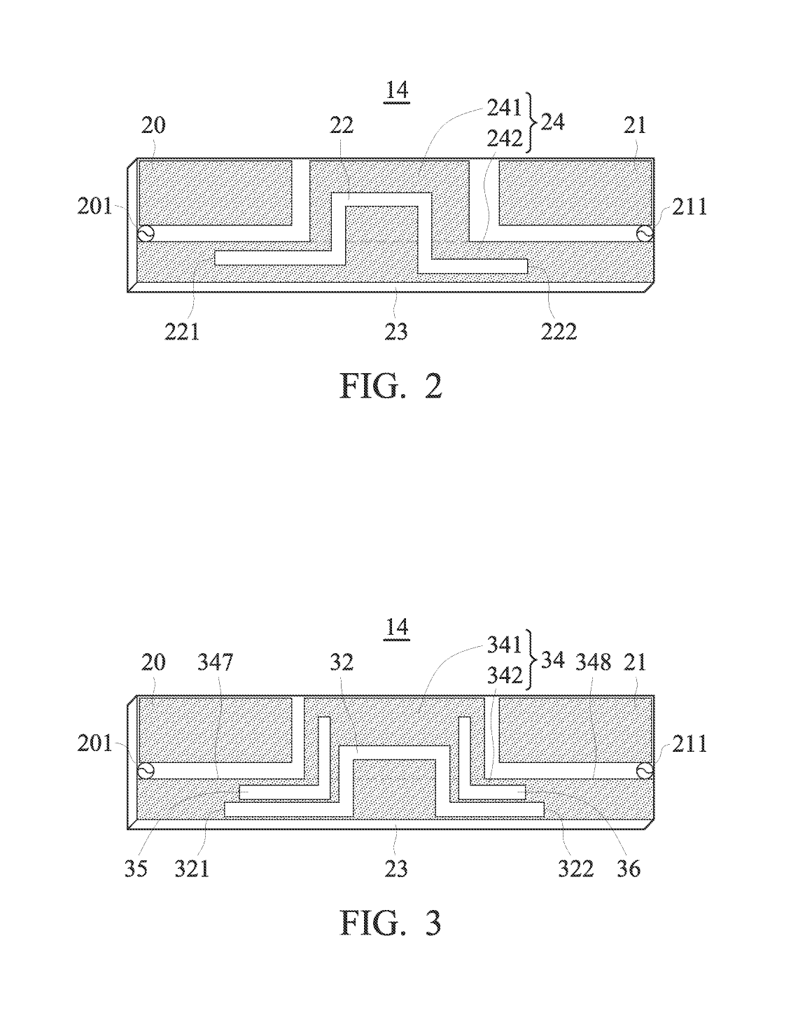

FIG. 2 is a diagram for illustrating the antenna system 14 according to an embodiment. In the embodiment, the antenna system 14 comprises a first antenna 20, a second antenna 21, and a ground plane 24. In a preferred embodiment, the ground plane 24 substantially has an inverted-T shape. The antenna system 24 may be formed on a dielectric substrate 23 (e.g., an FR4 substrate). The first antenna 20 is excited by a first signal source 201, and the second antenna 21 is excited by a second signal source 211. Each of the first antenna 20 and the second antenna 21 operates in at least a first band. The ground plane 24 comprises a protruded ground plane 241 and a main ground plane 242. The protruded ground plane 241 is located between the first antenna 20 and the second antenna 21. The main ground plane 242 is electrically coupled to the first conductive plane 12. The ground plane 24 has at least a first slot 22. The length of the first slot 22 is approximately equal to 0.5 wavelength of a frequency in the first band. A portion of the first slot 22 is located in the protruded ground plane 241. The first slot 22 has a first closed end 221 and a second closed end 222. The first closed end 221 and the second closed 222 end are both located in the main ground plane 242 and extend away from each other. The first closed end 221 is located between the first antenna 20 and the first conductive plane 12, and the second closed end 222 is located between the second antenna 21 and the first conductive plane 12. The first slot 22 resonates in the first band to attract surface currents on the ground plane 24, thereby reducing current coupling between the first antenna 20 and the second antenna 21. Accordingly, the invention can effectively increase the isolation between the first antenna 20 and the second antenna 21.

FIG. 3 is a diagram for illustrating the antenna system 14 according to another embodiment. FIG. 3 is similar in the antenna system structure to FIG. 2. The difference between them is that a ground plane 34 of the antenna system 14 shown in FIG. 3 further has a second slot 35 and a third slot 36, in addition to a first slot 32. The length of the first slot 32 is approximately equal to 0.5 wavelength of a frequency in the first band. A portion of the first slot 32 is located in a protruded ground plane 341. A first closed end 321 and a second closed 322 end of the first slot 32 are both located in a main ground plane 342 and extend away from each other. The first closed end 321 is located between the first antenna 20 and the first conductive plane 12, and the second closed end 322 is located between the second antenna 21 and the first conductive plane 12. The length of the second slot 35 and the length of the third slot 36 are both approximately equal to 0.5 wavelength of a frequency in a second band. A portion of the second slot 35 is located in the main ground plane 342, and another portion of the second slot 35 is located in the protruded ground plane 341. Similarly, a portion of the third slot 36 is located in the main ground plane 342, and another portion of the third slot 36 is located in the protruded ground plane 341. The second slot 35 is closer to an edge 347 of the ground plane 34 than the first slot 32, and the edge 347 of the ground plane 34 faces the first antenna 20. Similarly, the third slot 36 is closer to another edge 348 of the ground plane 34 than the first slot 32, and the edge 348 of the ground plane 34 faces the second antenna 21. The first slot 32 increases the isolation between the first antenna 20 and the second antenna 21 when the first antenna 20 and the second antenna 21 operate in the first band. The second slot 35 and the third slot 36 increase the isolation between the first antenna 20 and the second antenna 21 when the first antenna 20 and the second antenna 21 operate in the second band.

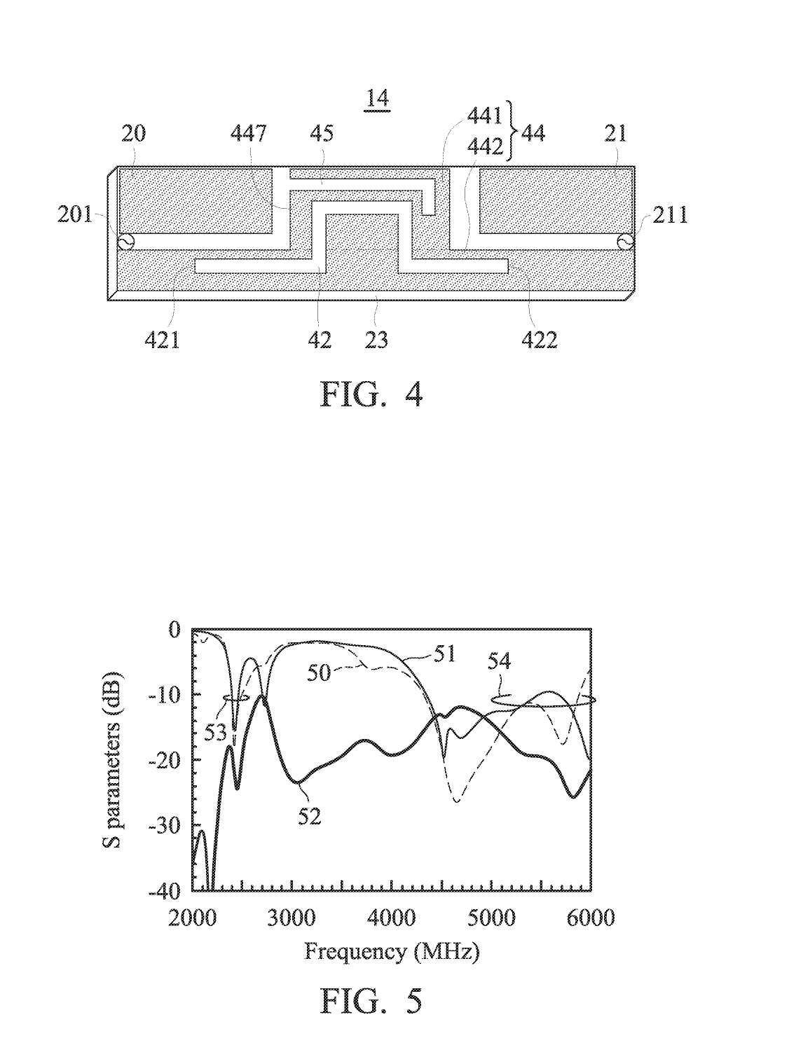

FIG. 4 is a diagram for illustrating the antenna system 14 according to an embodiment. FIG. 4 is similar in the antenna system structure to FIG. 2. The difference between them is that a ground plane 44 of the antenna system 14 shown in FIG. 4 further has an open slot 45, in addition to a first slot 42. The length of the first slot 42 is approximately equal to 0.5 wavelength of a frequency in the first band. A portion of the first slot 42 is located in a protruded ground plane 441. A first closed end 421 and a second closed 422 end of the first slot 42 are both located in a main ground plane 442 and extend away from each other. The first closed end 421 is located between the first antenna 20 and the first conductive plane 12, and the second closed end 422 is located between the second antenna 21 and the first conductive plane 12. The length of the open slot 45 is approximately equal to 0.5 wavelength of a frequency in the second band. In a preferred embodiment, the open slot 45 is located in the protruded ground plane 441, and an open end of the open slot 45 is located at an edge 447 of the protruded ground plane 441. The first slot 42 increases the isolation between the first antenna 20 and the second antenna 21 when the first antenna 20 and the second antenna 21 operate in the first band. The open slot 45 increases the isolation between the first antenna 20 and the second antenna 21 when the first antenna 20 and the second antenna 21 operate in the second band.

FIG. 5 is a diagram for illustrating S parameters of the antenna system 14 shown in FIG. 4 according to an embodiment. In an embodiment, the antenna system 14 has an area of about 495 mm² (55 mm by 9 mm), and each of the first conductive plane 12 and the second conductive plane 13 has an area of about 56000 mm² (280 mm by 200 mm). According to the criterion of 10 dB return loss, the reflection coefficient (S11) curve 50 of the first antenna 20 and the reflection coefficient (S22) curve 51 of the second antenna 21 both comprise a first band 53 and a second band 54. In a preferred embodiment, the first band 53 may cover a WLAN (Wireless Local Area Network) 2.4 GHz band (about from 2400 MHz to 2484 MHz), and the second band 54 may cover WLAN 5.2/5.8 GHz bands (about from 5150 MHz to 5350 MHz and from 5725 MHz to 5875 MHz). In the second embodiment, when the antenna system 14 shown in FIG. 4 performs MIMO operation in a WLAN system, the isolation (S21) curve 52 between the first antenna 20 and the second antenna 21 is lower than −20 dB in both the first band 53 and the second band 54. In addition, the antenna efficiency (including the return loss) of the first antenna 20 is approximately from 67% to 78% and from 82% to 86% in the first band 53 and the second band 54, respectively. The antenna efficiency (including the return loss) of the second antenna 21 is approximately from 60% to 81% and from 80% to 91% in the first band 53 and the second band 54, respectively. Thus, the antenna system 14 of the invention has good radiation efficiency in both the first band 53 and the second band 54. Note that the various kinds of antenna systems 14 shown in FIGS. 2, 3 and 4 each may be applied to the communication devices 100 and 200 shown in FIGS. 1A and 1B.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A communication device, comprising:
a first conductive plane; and
an antenna system, being substantially a planar structure, and substantially located at a first edge of the first conductive plane, wherein the antenna system comprises:
a first antenna, operating in at least a first band;
a second antenna, operating in at least the first band; and
a ground plane, substantially having an inverted-T shape, and comprising a main ground plane and a protruded ground plane, wherein the main ground plane is coupled to the first conductive plane, the protruded ground plane is located between the first antenna and the second antenna, the ground plane has at least a first slot, a length of the first slot is approximately equal to 0.5 wavelength of a frequency in the first band, a portion of the first slot is located in the protruded ground plane, the first slot has a first closed end and a second closed end, and the first closed end and the second closed end are located in the main ground plane and extend away from each other, and the first slot increases isolation between the first antenna and the second antenna.

2. The communication device as claimed in claim 1, wherein the antenna system is formed on a dielectric substrate.

3. The communication device as claimed in claim 1, wherein the antenna system is disposed on a plane which is substantially parallel to the first conductive plane and extends away from the first conductive plane.

4. The communication device as claimed in claim 1, wherein the first conductive plane is a supporting conductive board of an upper cover of a notebook computer.

5. The communication device as claimed in claim 1, wherein the first conductive plane is a supporting conductive board of a tablet computer.

6. The communication device as claimed in claim 1, further comprising:
a second conductive plane, coupled to the first conductive plane, wherein a second edge of the second conductive plane is close to the first edge of the first conductive plane, and the antenna system is substantially disposed between the first edge and the second edge.

7. The communication device as claimed in claim 1, wherein the first closed end of the first slot is located between the first antenna and the first conductive plane, and the second closed end of the first slot is located between the second antenna and the first conductive plane.

8. The communication device as claimed in claim 1, wherein the ground plane further has a second slot, a length of the second slot is approximately equal to 0.5 wavelength of a frequency in a second band, a portion of the second slot is located in the main ground plane, another portion of the second slot is located in the protruded ground plane, and the second slot increases isolation between the first antenna and the second antenna when the first antenna and the second antenna operate in the second band.

9. The communication device as claimed in claim 8, wherein the second slot is closer to an edge of the ground plane than the first slot, and the edge of the ground plane faces the first antenna or the second antenna.

10. The communication device as claimed in claim 1, wherein the ground plane further has an open slot, and open end of the open slot is located at an edge of the protruded ground plane, a length of the open slot is approximately equal to 0.5 wavelength of a frequency in a second band, and the open slot increases isolation between the first antenna and the second antenna when the first antenna and the second antenna operate in the second band.
